(19) United States
(12) Patent Application Publication
(10) Pub. No.: US 2006/0099553 A1
(43) Pub. Date: May 11, 2006

(54) Automatic teaching method for printed circuit board inspection system

(76) Inventors: Byoung-Oh Joo, Pyeongtaek-city (KR); Sang-Hoo Park, Suwon-city (KR); Joon-Young Jeong, Seoul (KR)

Correspondence Address: CANTOR COLBURN, LLP, 55 GRIFFIN ROAD SOUTH, BLOOMFIELD, CT, 06002, US

(21) Appl. No.: 10/512,928

(22) PCT Filed: Apr. 26, 2003
(86) PCT No.: PCT/KR03/00851

§ 371 Date: Aug. 15, 2005

(30) Foreign Application Priority Data
Apr. 29, 2002 (KR) 10-2002-0023483

(51) Int. Cl. G09B 19/00

(52) U.S. Cl. 434/224

(57) ABSTRACT

The present invention relates to an automatic teaching method for a circuit board inspection system and comprises a data transform step of transforming mounter data into data file for teaching; a coordinate transform step of corresponding coordinates for data for teaching transformed through the data transform step transform step with inspection system coordinates; and a teaching step of programming contents to be inspected based on data for teaching such as part coordinates, part names, reference names and part angles that are formed through the data transform step and coordinate transform step. An automatic teaching method for a circuit board inspection system according to the present invention not only completes teaching operation within a short period of time, but also substantially reduces set up time for a new circuit substrate by enabling automatic teaching utilizing mounter data of parts mounted on a forgoing actual circuit substrate.

### BACKGROUND OF THE INVENTION

1. Field of the invention

The present invention relates to a method for inspecting the state of parts of a printed circuit board, more particularly, to an automatic teaching method for a printed circuit board mounted inspection system which automatically teaches the inspection system inspection related information according to type of each printed circuit boards.

2. Description of Related Art

Generally, a printed circuit board inspection system, as a system for inspecting information on various parts adhered onto a printed circuit board, inspects various soldering defects such as no solder, short, position falling off and lead lift and whether appropriate parts are used or not by applying image processing technology to varieties of defects generated in automatic soldering process of the parts.

However, inspection related information such as name, position and shape of parts according to type of circuit boards should be taught to the inspection system in full since soldering position of various parts and inspection processing method are varied depending on types of the respective circuit boards.

Conventionally, the foregoing teaching operation has been manually done, and an inspection window for all parts has been manually arranged before being used after dividing the frame to maintain the number of frames as less as possible in the inspection system and obtaining paths of frame for a new circuit board.

However, the manual teaching operation has problems in that it not only requires lots of time and related knowledge, but also lengthens setup time for a new circuit board model.

On the other hand, although an automatic teaching method using a mounter data is introduced into a certain inspection system to solve those problems, automatic teaching can not be applied to all cases, and it is difficult to correspond coordinates for the mounter data with coordinates for the inspection system since corresponding types of a surface mounter are limited to extremely certain cases. Furthermore, there are problems in that it takes more time to correct the positions thereof since the coordinates for the mounter data are different from, thereby deviated from the actual coordinates for the mounted parts due to processing reasons.

### SUMMARY OF THE INVENTION

Therefore, it is an object of the present invention to provide an automatic teaching method for a circuit board inspection system that not only completes teaching operation within a short period of time, but also reduces setup time for a new circuit board by enabling accurate automatic teaching using mounter data of parts actually-mounted on the circuit board.

In order to achieve the foregoing objects, the present invention provides an automatic teaching method for a circuit board inspection system comprising a data transform step of transforming mounter data into data file for teaching; a coordinate transform step of corresponding coordinates for data for teaching transformed through the data transform step with inspection system coordinates; and a teaching step of programming contents to be inspected based on data for teaching such as part coordinates, part names, reference names and part angles that are formed through the data transform step and coordinate transform step.

The data transform step comprises a step of selecting editing menu from a main screen provided by program execution; an editing screen display step according selection of the editing menu; a step of calling up mounter data through the editing screen; a step of designating a region to transform data from the called up mounter data list; a step of inputting concerned items after analyzing the transformed data; and a step of forming a teaching file by storing the transformed data, wherein the automatic teaching method for a circuit board inspection system comprises the steps before the step of calling up mounter data or the step of designating a region to transform data; a step of transforming concerned items after analyzing data to be transformed; and a step of forming a data file for teaching by storing the transformed data, and wherein the automatic teaching method for a circuit board inspection system further comprises a step of setting data transform rule before the step of calling up mounter data or the step of designating a region to transform data.

The coordinate transform step comprises a step of selecting coordinate transform menu from a main screen provided by program execution; a coordinate transform screen display step according to selection of the coordinate transform menu; a step of calling up data file for teaching from the coordinate transform screen; a step of outputting information on the called up data file for teaching; a step of performing approximate coordinate transform through the outputted image data for the purpose of micro-coordinate transform; a step of performing micro-coordinate transform by designating specific parts; and a step of registering the transformed coordinates.

The teaching step comprises a step of selecting teaching menu from main screen provided by program execution; a teaching screen display step according to selection of the teaching menu; a step of proceeding automatic teaching through the teaching screen; and a step of finishing teaching after frame generation.

The the editing screen comprises a mounter data output window for outputting the called up mounter data; an environment setting window which is formed at one side of the mounter data output window to set various parameters for transforming mounter data; and a transform data output window which is formed at one side of the mounter data output window to output transform data for the designated mounter data.

The environment setting window comprises a coordinate reference for setting coordinate system of the mounter data; an direction unit for setting rotational angle unit of the mounter data; a coordinate unit for selecting coordinate unit of the mounter data; a separator for setting symbol for dividing between items of the mounter data; and a mounter type selection part for setting the coordinate reference, direction unit and coordinate unit so that operators reuse the selected mounter type not by setting environment again for the data type stored, but by selecting the mounter type only.

The coordinate transform screen comprises a circuit board image display window for displaying entire images of the circuit board and position of each parts inputted into the data file for teaching in a cross shape and displaying position of specific parts selected in a rectangular shape to distinguish the specific parts from general parts; a coordinate transform information window which is formed at one side of the circuit board image display window to display coordinate transformed information of each parts; a symmetric/rotational button which is formed at one side of the circuit board image display window to correspond images of parts with cross marks through dragging of the mouse with mouse adjusted to coordinate system by performing symmetrical or rotational transform on each of the parts inputted into the data file for teaching; a moving button which is formed at one side of the circuit board image display window to correspond the central point of part images of picture projected on an image display window with part coordinates selected on the coordinate transform information window through dragging of mouse by moving camera to position of parts selected through the coordinate transform information window; and a registration button which is formed at one side of the moving button to register transformed coordinates.

The teaching screen comprises an image display window for displaying images of parts to be taught; an automatic teaching tool window that is formed at one side of the image display window; a part group window which is formed at the upper part of the automatic teaching tool window to display a list of parts having the same name as parts selected from the part group window; part find buttons that are formed at the lower part of the part group window to teach position and region and inspection method of an inspection window to be actually inspected by finding parts that are not taught and moving to position of concerned parts; and a lump-sum teaching button that is installed at the lower part of the part find buttons to automatically form the inspection window.

The automatic teaching in the teaching process comprises the processes of moving a camera to x and y coordinates of parts having the same part names using as a standard part parts a reference name of which is registered in parts listed on the part group window, and automatically forming an inspection window having the same attribute as the standard part at the position using angles of the parts; and forming an inspection window having the same attribute as the standard part using position coordinates and rotation angles of parts to be taught to a position having the highest degree of similarity after grasping degree of similarity for images similar to the standard part found in a candidate region by performing pattern matching in which images for a taught standard part are compared with images for a candidate region of parts to be taught so that the automatically formed inspection window is automatically taught to an actual position of parts on a printing circuit board.

The position and region of the taught inspection window are prevented from being deviated by external factors such as mechanical properties of robot and distortion performance of camera by moving the camera to the center of a frame sequentially according to actual inspection sequence when including the inspection window into a frame formed in the frame generation, and adjusting position of the inspection windows again by pattern matching as in the automatic teaching process for each of the inspection windows to be included by photographing images.

### BRIEF DESCRIPTION OF THE DRAWINGS

Further-objects and advantages of the invention can be more fully understood from the following detailed description taken in conjunction with the accompanying drawing in which:

FIG. 1 is a flow chart schematically illustrating automatic teaching step according to one embodiment of the present invention;

FIG. 2 is a flow chart illustrating data transform step of the FIG. 1;

FIG. 3 is a flow chart illustrating coordinate transform step of the FIG. 1;

FIG. 4 is a flow chart illustrating teaching step of the FIG. 1;

FIG. 5a is a drawing showing a main screen of automatic teaching program according to one embodiment of the present invention;

FIG. 5b to FIG. 5h are image state diagrams showing the state that a series of editing processes are progressed through editing screen provided from the FIG. 5a;

FIG. 6a to FIG. 6d are image state diagrams showing the state that a series of coordinate transform processes are proceeded through coordinate transform screen provided from the FIG. 5a; and

FIG. 7a to FIG. 7d are image state diagrams showing the state that a series of teaching processes are progressed through teaching screen provided from the FIG. 5a.

<Explanation of symbols on major parts of the drawings>

| | |
|---|---|
| S1000: data transform step | S2000: coordinate transform step |
| S3000: teaching step | 1: main screen |
| 10: editing screen | 30: coordinate transform screen |
| 50: teaching screen | |

### DETAILED DESCRIPTION OF THE INVENTION

The present invention will now be described in detail in connection with preferred embodiments with reference to the accompanying drawings. For reference, like reference characters designate corresponding parts throughout several views.

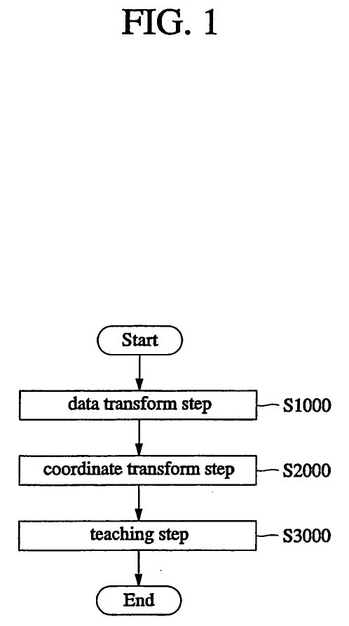

Referring to appending drawings, FIG. 1 to FIG. 7d, constitution and function by one embodiment of the present invention are described more in detail as follows:

As illustrated on FIG. 1, an automatic teaching method for a circuit board inspection system according to one embodiment of the present invention comprises a data transform step (S1000) for transforming mounter data for mounting parts on a circuit board (hereinafter referred to as “mounter data”) into data for teaching, a coordinate transform step (S2000) of corresponding coordinates of data for teaching transformed through the data transform step with coordinates of an inspection system for inspecting an actual mounting state of the circuit board, and a teaching step (S3000) of programming contents to be inspected based on data for teaching such as part coordinates, part names reference names and part angles formed through the data transform step (S1000) and coordinate transform step (S2000).

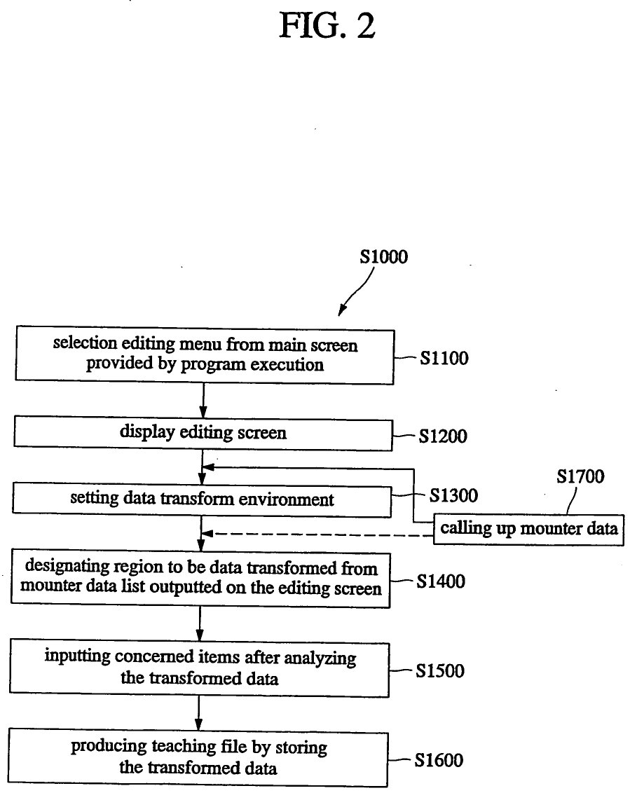

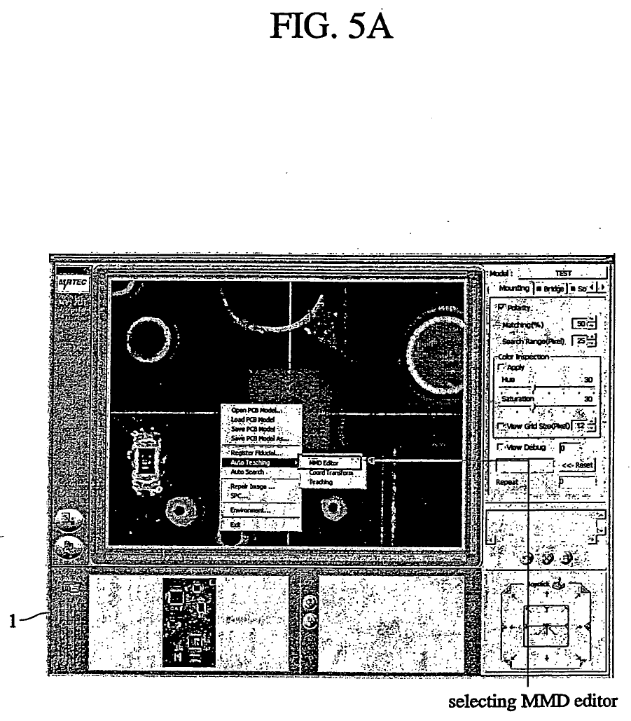

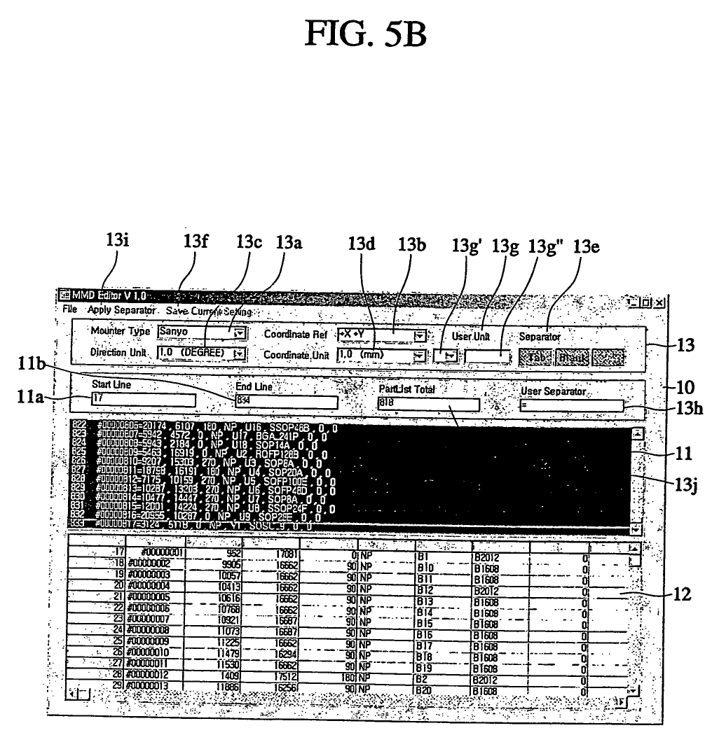

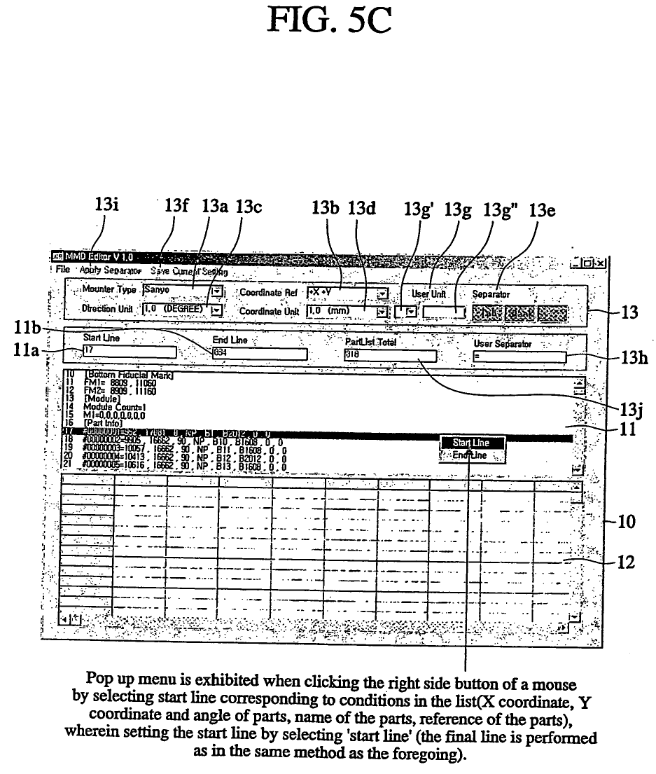

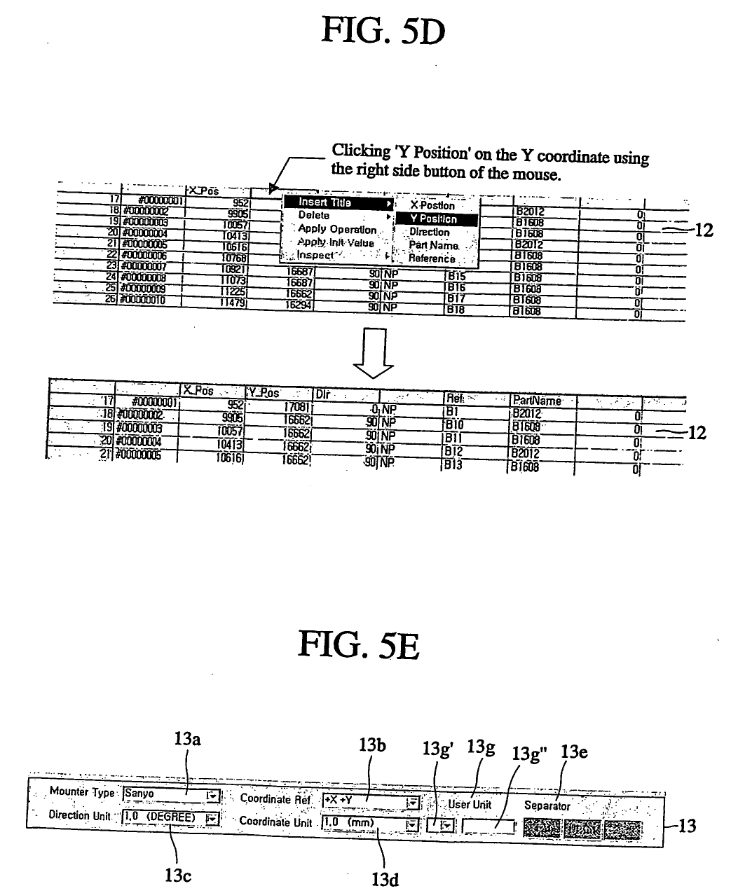

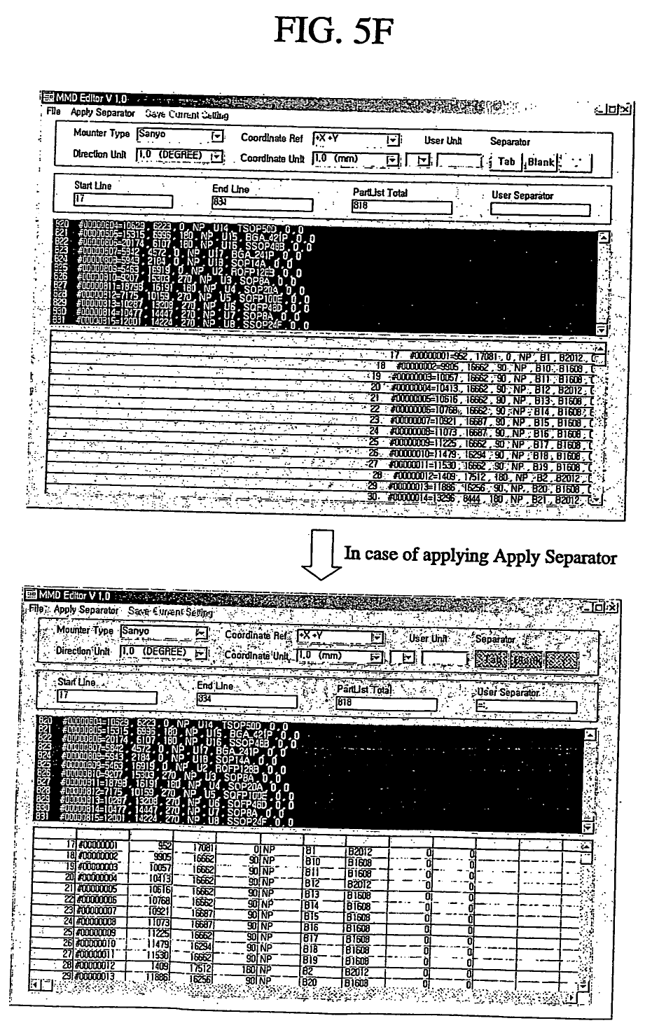

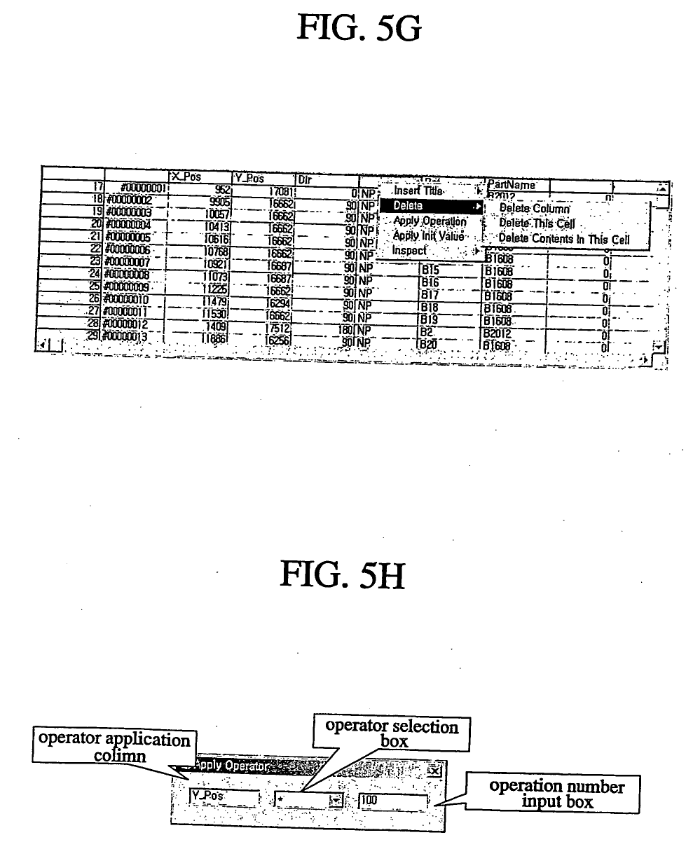

As illustrated in FIG. 2, the data transform step (S1000) comprises a step (S1100) of selecting editing menu after putting a pop up menu on the main screen by pressing the right side button of a mouse when a main screen 1 is outputted as in FIG. 5a as a user executes program as illustrated in FIG. 2, a step (S1200) of displaying an editing screen 10 as in FIG. 5b after the step (S1100) of selecting the editing menu, a step (S1300) of calling up mounter data through the editing screen 10, a step (S1400) of designating a region of data to be transformed from the output list when the called up mounter data is outputted through a mounter data output window 11 as illustrated in FIG. 5b, a step (S1500) in which the user transforms concerned items after analyzing the data to be transformed when the region designated data are outputted on a transform data output window 12 installed at the lower part of the mounter data output window 11, and a step (S1600) of forming a data file for teaching by storing the transformed data.

Furthermore, the data transform step (1000) further comprises a step (S1700) of setting data transform environment before the step (S1300) of calling up mounter data or the step (S1400) of designating a region for transforming data in the foregoing steps so as to set data transform conditions.

As illustrated in FIG. 5c, region designation in the step (S1400) of designating a region for transforming data is done by selecting a start line corresponding to items to be transformed into the data file for teaching (X coordinate, Y coordinate, angle, name and reference of parts), designating the start line by clicking the right side button of the mouse, and designating an end line by selecting a final line of a region to be transformed as in the same manner.

Next, a method for inputting the concerned items in the step (S1500) of transforming concerned items into the data outputted in a transform data output window 120 comprises the steps of positioning the mouse correspondingly to each items, forming a pop up menu window by clicking the right side button of the mouse, and displaying the selected items by clicking name of the concerned items after selecting insert title from the pop up menu as illustrated in FIG. 5d. Item names such as X coordinates, Y coordinates and angles of parts, part name and reference name are displayed by the method.

Next, environmental setting in the environment setting step (S1700) is enabled by inputting data into each designation parts of an environment setting window 13 provided on the editing screen 10 as illustrated in FIGS. 5b, 5c and 5e.

The environment setting window 13 comprises a mounter type selection part 13a for selecting types of mounter, a coordinate reference 13b for setting coordinate system of mounter data, a direction unit 13c for setting rotational angle unit of mounter data, a coordinate unit 13d for selecting coordinate unit of mounter data, and a separator 13e for dividing between items of the mounter data.

The operator does clicks a save current setting 13f menu formed at one side of the environment setting window 13 to store environment setting contents after setting and mapping the foregoing coordinate setting part 13b, direction unit selection part 13c and coordinate unit 13d after setting the coordinate reference 13b, direction unit 13c and coordinate unit 13d when an operator transforms mounter data frequently used into a data file for teaching so that the mounter type is used again by operator afterwards not by setting environment for the same data type, but by setting the mounter type only.

The coordinate reference 13b sets a coordinate system used in the mounter, and the coordinate system selected when transforming coordinates into the data file for teaching is transformed into a coordinate system for the inspection system.

The coordinate system is one selected from +X+Y, +X−Y, −X+Y, and −X−Y.

The coordinate unit 13d sets coordinate unit used in the mounter, wherein 1.0 mm, 0.01 mm, 1.0 inch and 1.0 mil are selected as a setting unit of the coordinate unit 13d, and a user column 13g is formed at one side of the coordinate unit 13d. The coordinate units set when transforming the selected setting unit into a data file for teaching are transformed into a micron (μm) unit that is a coordinate unit of the inspection system if one of the setting units is selected.

An operator input column 13g′ for inputting an operator and an editor box 13g″ for inputting values applied by the user are formed on the user column 13g.

The separator 13e selects tab, blank, rest, or a combination thereof when dividing items of the mounter data so that the items of the mounter data are divided by the tab, blank, rest, or the combination thereof.

The mounter data is read out after dividing items of the mounter data with a selected separator so that a data list is displayed on a mounter data output window.

On the other hand, a user separator column 13h is formed at one side of the separator 13e to read out mounter data, simultaneously use various separators and enter such symbols such as colon between a plurality of separators by dividing items of the mounter data using letters inputted by a user when the separators between the items of the mounter data are not in the separator 13e.

Furthermore, as illustrated in FIG. 5f, an apply separator 13i is formed at one side of the environment setting window 13 so that items are classified by the separator if clicking the apply separator 13i when the separator is not set in the previous step, or the set separator is reset.

In FIGS. 5b and 5c, the non-described symbol 13j represents a part list total window for showing the number of parts before being selected.

Unnecessary column items are removed from the separated total data in FIG. 5g as a drawing illustrating other examples for editing data of the foregoing transform data output window 12. The column is removed by selecting column to be removed, and selecting column delete of delete item displayed on the pop up menu window by clicking the right side button of the mouse.

Furthermore, a delete this cell menu is formed on the pop up menu window so that a value on the right row is moved to the deleted cell as the selected cell is being deleted when clicking the delete this cell menu after moving the mouse to position of a cell to be deleted.

Furthermore, a menu of delete contents in this cell is formed on the pop up menu window to delete contents of the selected cell.

An operator input window as illustrated in FIG. 5h, a drawing for showing an operator editing example, is appeared by selecting an apply operation menu from the pop up menu window as shown in the FIG. 5g to apply an operator to the selected column by selecting a column.

A column for applying the selected operator and an operator selection box are formed on the operator input window, and an operation number input box for inputting operation number to be applied during operation is formed at one side of the operator input window so that part angle units and coordinate units are manually transformed by a user.

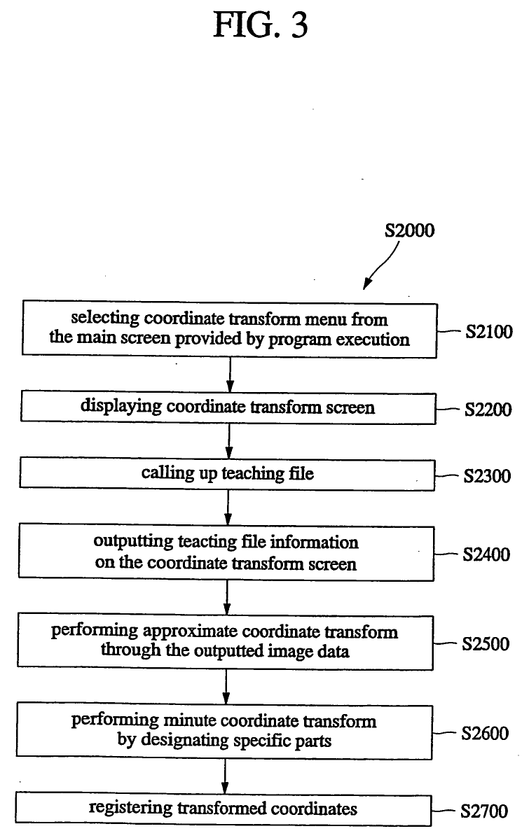

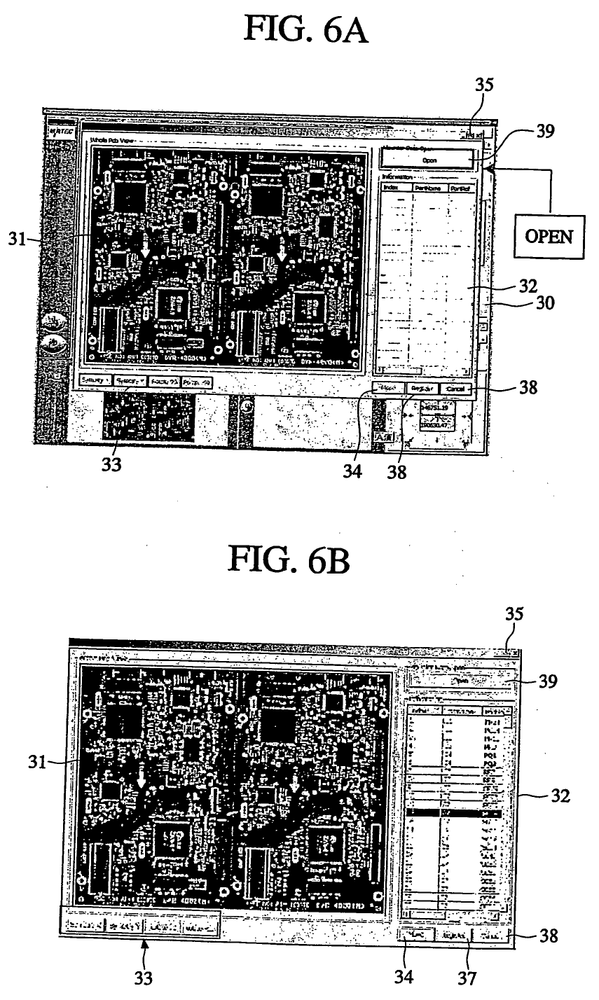

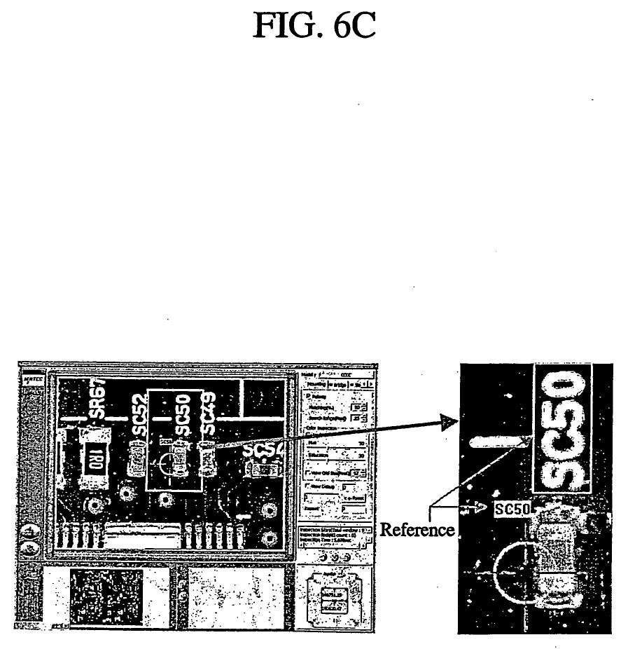

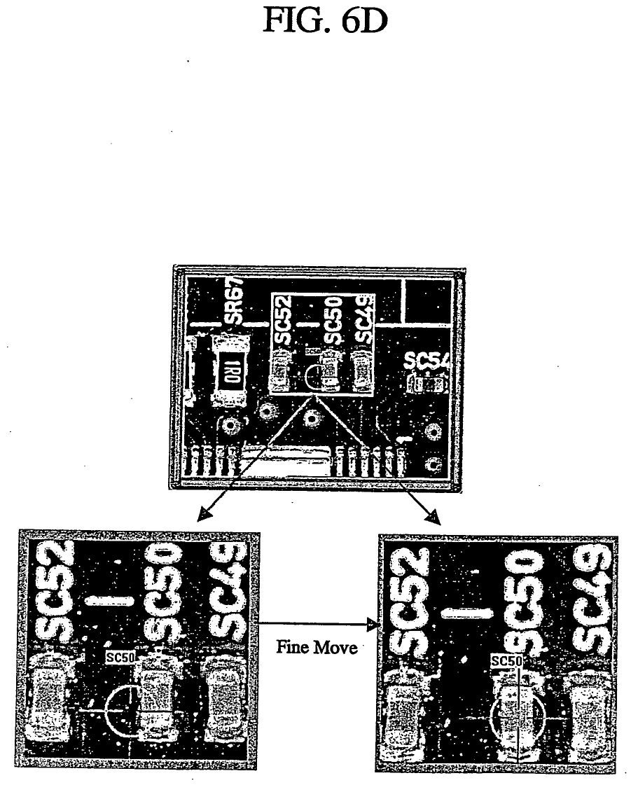

Next, the coordinate transform step (S2000) comprises a step (S2100) of selecting a coordinate transform menu after putting a pop up menu on the main screen 1 by pressing the right side button of the mouse if a main screen 1 as illustrated in FIG. 5a is outputted as the user is executing a program as illustrated in FIG. 3, a step (S2200) of outputting a coordinate transform screen 30 as in FIG. 6a after the step (S2100) of selecting the coordinate transform menu, and a step (S2300) of calling up a teaching file stored the data transform step (S1000) through the coordinate transform screen 30.

Furthermore, the coordinate transform step (S2000) comprises a step (S2400) of outputting information on the teaching file onto the coordinate transform screen 30, a coordinate transform step (S2500) in which a user roughly executes coordinate transform through the called up information on the teaching file, a step (S2600) of executing micro coordinate transform by designating specific parts, and a step (S2700) of registering the transformed coordinates.

A circuit board image display window 31 and a coordinate transform window 32 are formed on the coordinate transform screen 30 in the step (S2300) of calling up the data file for teaching as illustrated in FIG. 6b so that position of each parts inputted into a current data file for teaching is indicated in a cross shape on an image of the circuit board (a part expressed on the screen in black) on the circuit board image display window 31, position of specific parts selected is displayed in a rectangular shape to distinguish the specific parts from ordinary parts, and contents of data file for teaching are displayed on the coordinate transform window 32.

Next, in the coordinate transform step (S2500), position of cross is changed when dragging the mouse to a desired position by clicking the left side button of the mouse in the state that a cross showing part positions on a picture on circuit board images is indicated on the circuit board image display window 31, and data of coordinates transformed as much as displaced position are shown on the coordinate transform window 32 with data of the coordinates being renewed when releasing click of the left side button of the mouse at position where the parts correspond with cross marks.

A micro coordinate transform execution step (S2600) can be performed only by corresponding the cross with the center of all parts of circuit board image of the circuit board image display window 31.

The coordinate transform step (S2500) is also performed through a symmetrical/rotational button 33 formed at one side of the circuit board image display window 31.

That is, symmetrical or rotational transform can be carried out by clicking the symmetrical/rotational button 33 in case that cross distribution shown on the circuit board image display window 31 is symmetrical to part distribution of the circuit board image on the basis of X and Y axes or rotated to angles of +90 degrees and −90 degrees for part distribution of the circuit board image.

The coordinate transform window 32 shows coordinate transformed information of each part, wherein the information comprises index, name, reference, rotational angle, X axis coordinate and Y-axis coordinate of the parts.

Next, the micro coordinate transform execution step (S2600) is described as follows referring to FIG. 6c and FIG. 6d.

First, a red quadrangle is indicated at position of the part selected on the circuit board image display window 31 to distinguish the specific parts from ordinary parts when a user selects specific parts from a part list of the coordinate transform window 32, and a camera for expanding and projecting an image of the part of the circuit board inspection system is moved to position of selected parts by clicking a move button 34 formed on one side of the coordinate transform window 32.

The coordinate transform screen 30 is closed, and a screen box of parts projected by the camera is outputted on a main screen 1 as in FIG. 6c by clicking a minimization button 35 formed on the upper right side of the coordinate transform screen 30 if the camera is moved.

A cross mark shown on the screen indicates the central position of a part selected from the coordinate transform window 32, wherein micro coordinate transform is executed by moving a camera in the state that the left button of a mouse is clicked in a moving mode so that the center of the part corresponds with the cross marked part as illustrated in FIG. 6d, thereby corresponding the cross mark with the center of the part if a cross mark does not correspond with the central position of a specific part shown on a screen.

A register button 37 is formed at one side of the move button 34 so that the foregoing coordinate transform data is registered by pressing the register button 37.

A register button 37 is formed at one side of the move button 34 so that the foregoing coordinate transform data are registered by pressing the register button (37).

A cancel button 38 is formed at one side of the move button 34 to cancel the coordinate transform process and close a dialogue box.

The non-described symbol 39 represents an open button for calling up a data file for teaching.

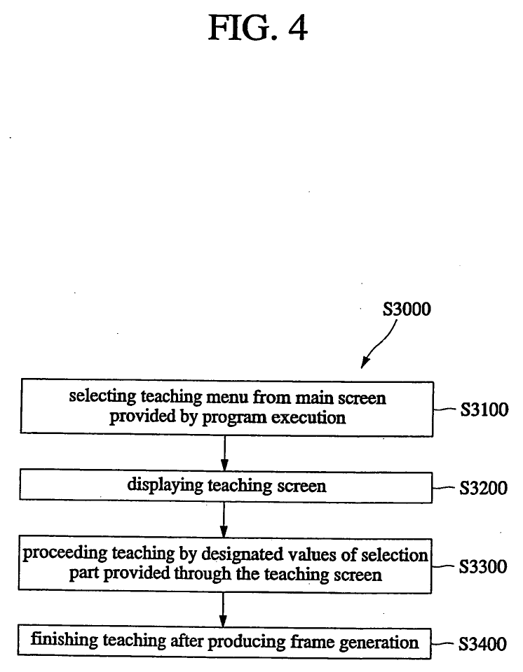

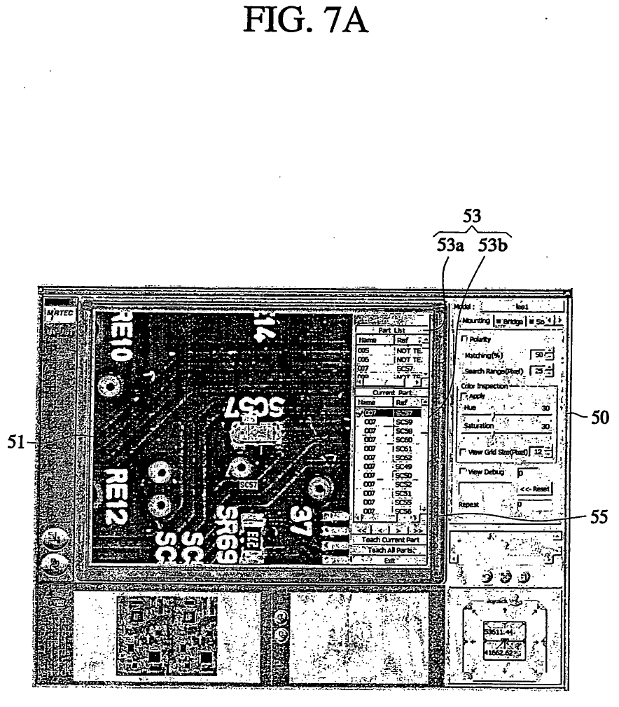

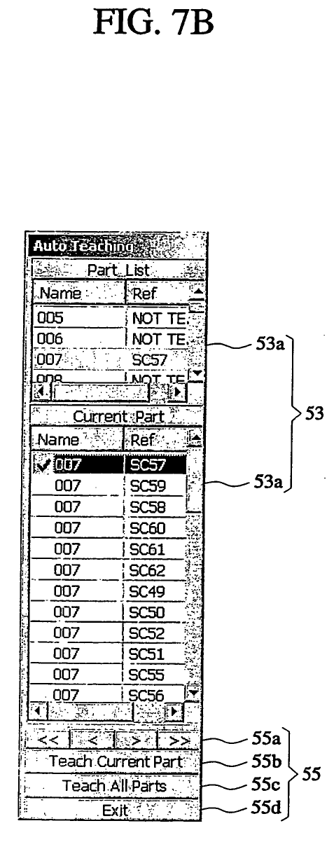

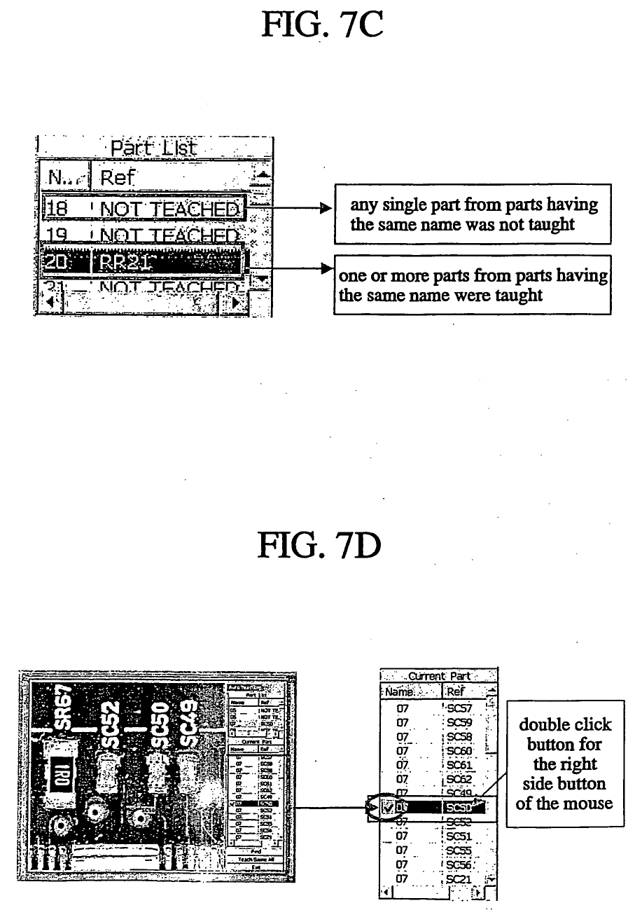

Next, the teaching step (S3000) comprises a step (S3100) of selecting a teaching menu from a main screen 1 provided by program execution as illustrated in FIG. 4, a step (S3200) of showing a teaching screen 50 as in FIG. 7a according to selection of the teaching menu, a teaching proceeding step (S3300) of proceeding teaching by selecting a teaching object, and a step (S3400) of terminating teaching after performing frame generation if teaching proceeding is completed.

A teaching part indication window 51 for indicating a part to be taught is formed on the teaching screen 50, an automatic teaching tool window is formed at one side of the teaching part display window 51, and an automatic teaching list window 53 and an automatic teaching button part 55 for automatic teaching are formed on the automatic teaching tool window as illustrated in FIG. 7b.

A part group window 53a for showing a list of the whole parts is formed on the automatic teaching list window 53, and a part list window 53b for showing a list of parts having the same name as parts selected from the part group window 53a is formed at the lower side of the part group window 53a.

If even one component having the same name as illustrated in FIG. 7c is taught in reference name for each part in the part group window 53a, reference name of a part that is taught very last as having the same name is registered.

On the other hand, the reference name is registered as “NOT TAUGHT” in case that not a single part out of the parts having the same name is taught.

The part list window 53b shows a list of parts having the same name as parts selected from the part group window 53a as illustrated in FIG. 7d, and a camera is moved to position of the selected part when double clicking the left side button of the mouse with a mouse positioned at a part to be taught on the part list window 53b.

After parts to be taught are displayed on the teaching part display window 51, reference names of concerned parts are displayed on the part group window 53a while check marks shown on the concerned parts of the part list window 53b by first teaching a window for mounting state inspection for inspecting position disconnection, defects and mis-insertion of the concerned parts and teaching a window for soldering state inspection of the concerned parts in succession, wherein the window for mounting state inspection should be taught first since the window for soldering state inspection is designated as corresponding data to the window for mounting state inspection.

As illustrated in FIG. 7b, an automatic teaching button 55 comprises a find button 55a that is moved to parts not taught, a teach current part button 55b for finding and automatically teaching parts having the same name as the parts selected from the part group window 53a, a teach all parts button 55c for finding and automatically teaching parts having the same name as all parts of the part group window 53a, and an exit button 55d for finishing automatic teaching after forming a frame.

The find button 55a comprises four buttons of a << button for moving to position thereof to find parts that are not taught among the inspected parts by finding parts that are at the previous positions of currently selected parts from the part group window 53a in reverse order and inspecting parts having the same name as the found parts in order; a < button for moving to position thereof to find parts that are not taught among the inspected parts by inspecting parts that are in the previous position of current selected parts among parts shown on the part list window 53b in reverse order; a >> button for moving to position thereof to find parts that are not taught among the inspected parts by finding parts that are in the following positions of the currently selected parts from the part group window 53a in order and inspecting parts having the same name as the found parts in order; and a > button for moving to position thereof to find parts that are not taught among the inspected parts by inspecting parts that are in the following positions of currently selected parts among parts shown on the part list window 53b in order.

The teach current part button 55b sets the selected parts as a standard part if reference name is registered on parts that are selected from the part group window 53a and finds to automatically teach non-taught parts having the same name as the standard part.

The teach all parts button 55c sets all parts which reference name is registered as a standard part on the part group window 53a in order and finds to automatically teach non-taught parts having the same name as the standard part.

On the other hand, the position of an inspection window formed can be inaccurate as position of an object part to be taught does not accurately corresponds with coordinate data due to various reasons such as error of robot, mounting state of a circuit board and problems of mounting process although automatic teaching is possible only with position coordinates and rotational angles of the object part to be taught.

A pattern matching for comparing image for a standard part that is automatically taught with an image of a candidate region of parts that is to be taught using lump-sum teaching buttons (55b,55c) as a means for solving the foregoing problems is performed so that an inspection window having the same attribute as the standard part is formed on an accurate position of parts using position coordinates and rotational angles of parts that are taught to a position having the highest degree of similarity after grasping degree of similarities for the images similar to the standard part found in the candidate region, and the inspection window is not formed in case that the minimum degree of similarity standard is not satisfied in the whole candidate region so that the inspection window is formed on the next parts having the same attribute as the standard part after they are found.

Next, frame generation is described as follows:

First, frame displays an image photographed once by a camera into a region, wherein the frame generation is meant to minimize the number of frames by optimizing the moving range of the camera, wherein an effect for minimizing inspection time is obtained by minimizing the number of frames.

The automatic teaching step is exited after frames are formed on all inspection windows that are automatically taught to the present time by pressing the exit button 55d when finishing automatic teaching.

The frame generation is a process of forming frames and including the inspection windows included in the formed frames into the frame so that the largest numbers of part units are included for taught inspection windows that are not included in the frame until all inspection windows are included in the frame.

On the other hand, position and region of the inspection window are prevented from being deviated by external factors such as mechanical properties of robot and distortion performance of camera by moving the camera to the center of a frame sequentially according to actual inspection sequence as a position of the formed frame when including the inspection window into the formed frame, and adjusting position of the inspection windows again by pattern matching as in the automatic teaching process for each of the inspection windows to be included by photographing images.

While the invention has been particularly shown and described with reference to preferred embodiments thereof, it will be understood by those skilled in the art that the foregoing and other changes in form and details may be made therein without departing from the spirit and scope of the invention.

What is claimed is:

1. An automatic teaching method for a circuit board inspection system comprising:
a data transform step of transforming mounter data into data file for teaching;
a coordinate transform step of corresponding coordinates for data for teaching transformed through the data transform step with inspection system coordinates; and
a teaching step of programming contents to be inspected based on data for teaching such as part coordinates, part names, reference names and part angles that are formed through the data transform step and coordinate transform step.

2. The automatic teaching method for a circuit board inspection system according to claim 1, wherein the data transform step comprises a step of selecting editing menu from a main screen provided by program execution; an editing screen display step according selection of the editing menu; a step of calling up mounter data through the editing screen; a step of designating a region to transform data from the called up mounter data list; a step of inputting concerned items after analyzing the transformed data; and a step of forming a teaching file by storing the transformed data, wherein the automatic teaching method for a circuit board inspection system comprises the steps before the step of calling up mounter data or the step of designating a region to transform data; a step of transforming concerned items after analyzing data to be transformed; and a step of forming a data file for teaching by storing the transformed data, and wherein the automatic teaching method for a circuit board inspection system further comprises a step of setting data transform rule before the step of calling up mounter data or the step of designating a region to transform data.

3. The automatic teaching method for a circuit board inspection system according to claim 1, wherein the coordinate transform step comprises a step of selecting coordinate transform menu from a main screen provided by program execution; a coordinate transform screen display step according to selection of the coordinate transform menu; a step of calling up data file for teaching from the coordinate transform screen; a step of outputting information on the called up data file for teaching; a step of performing approximate coordinate transform through the outputted image data for the purpose of micro-coordinate transform; a step of performing micro-coordinate transform by designating specific parts; and a step of registering the transformed coordinates.

4. The automatic teaching method for a circuit board inspection system according to claim 1, wherein the teaching step comprises a step of selecting teaching menu from main screen provided by program execution; a teaching screen display step according to selection of the teaching menu; a step of proceeding automatic teaching through the teaching screen; and a step of finishing teaching after frame generation.

5. The automatic teaching method for a circuit board inspection system according to claim 2, wherein the editing screen comprises a mounter data output window for outputting the called up mounter data; an environment setting window which is formed at one side of the mounter data output window to set various parameters for transforming mounter data; and a transform data output window which is formed at one side of the mounter data output window to output transform data for the designated mounter data.

6. The automatic teaching method for a circuit board inspection system according to claim 5, wherein the environment setting window comprises a coordinate reference for setting coordinate system of the mounter data; a direction unit for setting rotational angle unit of the mounter data; a coordinate unit for selecting coordinate unit of the mounter data; a separator for setting symbol for dividing between items of the mounter data; and a mounter type selection part for setting the coordinate reference, direction unit and coordinate unit so that operators reuse the selected mounter type not by setting environment again for the data type stored, but by selecting the mounter type only.

7. The automatic teaching method for a circuit board inspection system according to claim 3, wherein the coordinate transform screen comprises a circuit board image display window for displaying entire images of the circuit board and position of each parts inputted into the data file for teaching in a cross shape and displaying position of specific parts selected in a rectangular shape to distinguish the specific parts from general parts; a coordinate transform information window which is formed at one side of the circuit board image display window to display coordinate transformed information of each parts; a symmetric/rotational button which is formed at one side of the circuit board image display window to correspond images of parts with cross marks through dragging of the mouse with mouse adjusted to coordinate system by performing symmetrical or rotational transform on each of the parts inputted into the data file for teaching; a moving button which is formed at one side of the circuit board image display window to correspond the central point of part images of picture projected on an image display window with part coordinates selected on the coordinate transform information window through dragging of mouse by moving camera to position of parts selected through the coordinate transform information window; and a registration button which is formed at one side of the moving button to register transformed coordinates.

8. The automatic teaching method for a circuit board inspection system according to claim 4, wherein the teaching screen comprises an image display window for displaying images of parts to be taught; an automatic teaching tool window that is formed at one side of the image display window; a part group window which is formed at the upper part of the automatic teaching tool window to display a list of parts having the same name as parts selected from the part group window; part find buttons that are formed at the lower part of the part group window to teach position and region and inspection method of an inspection window to be actually inspected by finding parts that are not taught and moving to position of concerned parts; and a lump-sum teaching button that is installed at the lower part of the part find buttons to automatically form the inspection window.

9. The automatic teaching method for a circuit board inspection system according to claim 8, wherein the automatic teaching in the teaching process comprises the processes of moving a camera to x and y coordinates of parts having the same part names using as a standard part parts a reference name of which is registered in parts listed on the part group window, and automatically forming an inspection window having the same attribute as the standard part at the position using angles of the parts; and forming an inspection window having the same attribute as the standard part using position coordinates and rotation angles of parts to be taught to a position having the highest degree of similarity after grasping degree of similarity for images similar to the standard part found in a candidate region by performing pattern matching in which images for a taught standard part are compared with images for a candidate region of parts to be taught so that the automatically formed inspection window is automatically taught to an actual position of parts on a printing circuit board.

10. The automatic teaching method for a circuit board inspection system according to claim 4 is characterized in that position and region of the taught inspection window are prevented from being deviated by external factors such as mechanical properties of robot and distortion performance of camera by moving the camera to the center of a frame sequentially according to actual inspection sequence when including the inspection window into a frame formed in the frame generation, and adjusting position of the inspection windows again by pattern matching as in the automatic teaching process for each of the inspection windows to be included by photographing images.
